(19) United States
(12) Patent Application Publication
(10) Pub. No.: US 2026/0111763 A1
(43) Pub. Date: Apr. 23, 2026

(54) SYSTEM FOR GENERATING A KNOWLEDGE BASE FROM GROUP CHAT DATA BY LEVERAGING AI MODELS

(71) Applicant: Celligence International LLC, Guaynabo, PR (US)

(72) Inventors: Pavan AGARWAL, Dorado, PR (US); Gabriel Albors Sanchez, San Juan, PR (US); Jonathan Ortiz Rivera, San Juan, PR (US); Dennis J. Borrero, San Juan, PR (US); Arindam Brahma, Aliso Viejo, CA (US)

(73) Assignee: Celligence International LLC, Guaynabo, PR (US)

(21) Appl. No.: 19/360,054

(22) Filed: Oct. 16, 2025

Related U.S. Application Data
(60) Provisional application No. 63/709,349, filed on Oct. 18, 2024.

(51) Int. Cl. G06N 5/022

(52) U.S. Cl. CPC G06N 5/022

(57) ABSTRACT

The system automatically generates a structured knowledge base from group chat data by leveraging AI models. It uses automated labeling and annotation to create training data, trains classification and extraction models to detect user intents and entities, and verifies extracted knowledge against subsequent chat content and external data sources. The system dynamically responds to user queries using the verified knowledge base, enabling accurate, context-aware answers with reduced computational requirements.

### RELATED APPLICATIONS

This application claims the benefit of U.S. Provisional Application No. 63/709,349 filed on Oct. 18, 2024, the entirety of which is incorporated herein by reference.

### BACKGROUND

Group chat messaging platforms are widely used for both personal and professional communication, enabling users to share information, ask questions, and collaborate in real time. Despite their widespread adoption, such platforms face significant limitations when it comes to extracting, organizing, and retrieving valuable information from the large volumes of unstructured conversational data they generate.

Due to these challenges, there is a growing need for systems that can automatically transform unstructured group chat data into a structured, persistent knowledge base. Such systems would allow users to meaningfully access and interact with the wealth of information exchanged in group chats, while AI models trained on labeled chat data would provide the capability to understand user intent, extract key entities, and generate accurate responses to complex queries.

### SUMMARY

In accordance with one or more embodiments, the disclosed system automatically generates a structured knowledge base from data exchanged within a group chat messaging platform. The system utilizes the content of user conversations to generate a labeled training dataset, which is used to train classification and extraction models that organize information from group chat messages into knowledge base entries. The system further employs AI architecture to dynamically respond to user queries using the verified knowledge base, enabling accurate and context-aware answers.

The disclosed system can be integrated with any group chat platform, allowing users to access relevant information without manually reviewing message histories or relying solely on basic keyword search functions. By transforming unstructured group conversations into a persistent and verified knowledge base, the system provides technical improvements in information retrieval, scalability, and accuracy compared to conventional messaging platforms.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A depicts a network including a group chat data knowledge base generator platform powered by AI architecture, according to an implementation of the disclosure.

FIG. 1B illustrates an exemplary schematic diagram of a computer-based architecture of an AI engine of the AI architecture powering the group chat data knowledge base generator platform in FIG. 1A, according to an implementation of the disclosure.

FIG. 2A illustrates an exemplary schematic diagram of a computer-based architecture of the AI engine in FIG. 1B in greater detail, according to an implementation of the disclosure.

FIG. 2B illustrates an exemplary schematic diagram of a computer-based architecture of a procedural function framework of the AI engine in FIG. 2A, according to an implementation of the disclosure.

FIG. 3 illustrates an exemplary process of the AI engine for responding to queries of FIG. 1A, according to an implementation of the disclosure.

FIG. 4 illustrates an example computing system that may be used in implementing various features of embodiments of the disclosed technology.

Described herein are systems and methods for a group chat data knowledge base generator platform powered by AI architecture. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

Most group chat platforms (e.g., Slack®, WhatsApp®, Microsoft Teams®) offer basic search functionalities, allowing users to search for keywords or phrases. However, these searches are often rudimentary and limited to exact matches or keyword-based filtering, making it difficult to extract meaningful insights or answers from the chat history. Users frequently struggle to locate relevant past conversations or retrieve valuable information buried within long chat threads.

In environments where important knowledge is shared through chats—such as work teams, community groups, or educational forums—users are unable to efficiently locate information, leading to knowledge loss or repeated questions. The inability to quickly access important data reduces the value of group chat platforms for long-term knowledge retention and weakens their potential as knowledge-sharing tools.

Group chat conversations are often unstructured, with information scattered across multiple messages, sometimes filled with irrelevant content such as casual banter or off-topic discussions. Unlike organized databases or knowledge management systems, chat platforms do not structure information in a way that makes it easy to extract specific details. the unstructured nature of chats makes it difficult to generate actionable insights or structured knowledge from conversations. Important data is mixed with noise, making it harder for users or systems to derive useful information in a reliable manner.

Chat platforms do not inherently understand the context of conversations. While a user might ask a question about a specific topic, current systems are unable to understand the full context, leading to generic or irrelevant responses. Platforms are not equipped to interpret and generate responses based on the historical conversation, making them inefficient at addressing user queries meaningfully. This lack of contextual awareness limits the ability of group chats to function as a true knowledge base. Users may need to manually sift through long chat histories to find related content, wasting time and making the platform less effective for information retrieval.

Presently disclosed is a system that automatically generates a structured knowledge base from the unstructured data exchanged in group chats. The system leverages AI models to first automatically label and annotate selected group chat messages used to train the model to that ensure the system can understand and respond to complex user queries to allow users to meaningfully interact with the wealth of information shared in group chat. The AI models implement an architecture that leverages an AI engine for dynamic task execution and knowledge retrieval, combined with classification and extraction models trained on data from group chat conversations.

The group chat data knowledge base generator platform includes a plurality of modules such as data collection module, data labeling and annotation module, model training module, knowledge base generator module, data verification module, response building module, and user query module. For example, the group chat data knowledge base generator platform uses data collection module to integrate with any group chat messaging platform to continuously capture, and preprocess all exchanged messages and content. The data labeling and annotation module automatically labels entities and classifies intents within the collected data, creating a high-quality dataset for training the classification and extraction models.

The model training module uses the labeled data to train the classification model and extraction model. These models learn to understand user queries, detect intents, and extract relevant entities. The knowledge base generator module analyzes the preprocessed and labeled data to construct a dynamic knowledge base containing relevant information, frequently asked questions, and key insights extracted from the group chat. The data labeling and annotation module automatically labels entities and classifies intents within the collected data, creating a high-quality dataset for training the classification and extraction models.

The knowledge base generator analyzes the preprocessed and labeled data to construct a dynamic knowledge base containing relevant information, frequently asked questions, and key insights extracted from the group chat.

The proposed system addresses the limitations of current group chat messaging platforms. By transforming group chat content into a structured, searchable knowledge base, users can quickly find relevant information without having to manually search through long, disorganized chat histories.

The combination of AI models and the cell engine ensures that user queries are understood in context, providing more accurate and meaningful responses based on the content of past group chats.

The system automatically labels, categorizes, and updates the knowledge base, reducing the need for manual data management and enabling the system to grow as new conversations take place.

Users can leverage past conversations and shared knowledge more effectively, turning group chats into a powerful collaborative tool that captures and reuses information across a team or community.

The proposed system addresses the limitations of current group chat messaging platforms by generating a knowledge base from user interactions, labeling training data to improve AI models, and leveraging a dynamic cell engine architecture to respond intelligently to user queries. This system offers significant improvements in how users interact with chat data, providing more efficient information retrieval, meaningful responses, and automated knowledge management. By enabling users to better access and utilize the wealth of information exchanged in group chats, the system transforms group messaging into a powerful knowledge-sharing platform.

By using the AI engine offers significant improvements in how users interact with chat data, providing more efficient information retrieval, meaningful responses, and automated knowledge management. By enabling users to better access and utilize the wealth of information exchanged in group chats, the system transforms group messaging into a powerful knowledge-sharing platform, without significantly increasing the computational resources. For example, unlike traditional NLP models that demand significant computing power for training on specific datasets, the present system uses AI architecture model that is lightweight and uses minimal CPU and GPU resources. This efficiency is achieved through its dynamic response generation approach rather than relying on a pre-trained single-purpose model.

The system introduces several technical improvements, including enhanced scalability and adaptability. For example, the modular nature of the AI engine allows for scalability by accommodating a growing number of users and groups with diverse needs. The architecture can easily integrate new features or services, such as dynamic content sharing or real-time event updates, without requiring a complete overhaul. It also supports a stateless design, meaning the system can efficiently manage multiple sessions and interactions without maintaining complex state information, which is particularly useful for handling high user volumes.

Conventional chat platforms treat group conversations as ephemeral and unstructured, making it difficult to extract durable, verifiable knowledge. Messages are typically consumed in real time and lost in the noise of unrelated dialogue. Prior systems may apply keyword search or lightweight sentiment analysis but do not transform conversational streams into persistent, structured knowledge that can be queried reliably.

Embodiments of the disclosed system provide technical improvements by automatically generating a structured knowledge base from group chat data. A data collection module ingests chat messages, and a labeling module 124 automatically annotates those messages with metadata such as user intent, named entities, and domain-specific tags. Unlike conventional approaches that require manual curation, the labeling process is automated and continuously updated as new chats arrive.

A knowledge base generator 128 then organizes the annotated data into structured and unstructured entries within a knowledge base data store 108. The system further employs a verification module 130 that cross-checks extracted knowledge against subsequent chat messages and, in some embodiments, external trusted data sources. This ensures that evolving information (e.g., corrected facts, updated availability, or consensus agreements) is incorporated, reducing error propagation and improving accuracy.

As a result, the system transforms unstructured, high-volume group chats into a persistent and verified knowledge base. User queries are answered against this evolving resource rather than raw chat text, enabling accurate, context-aware responses. This architecture provides improvements in efficiency, reliability, and scalability compared to conventional LLM-based systems, which typically require retraining or manual annotation to handle domain-specific knowledge.

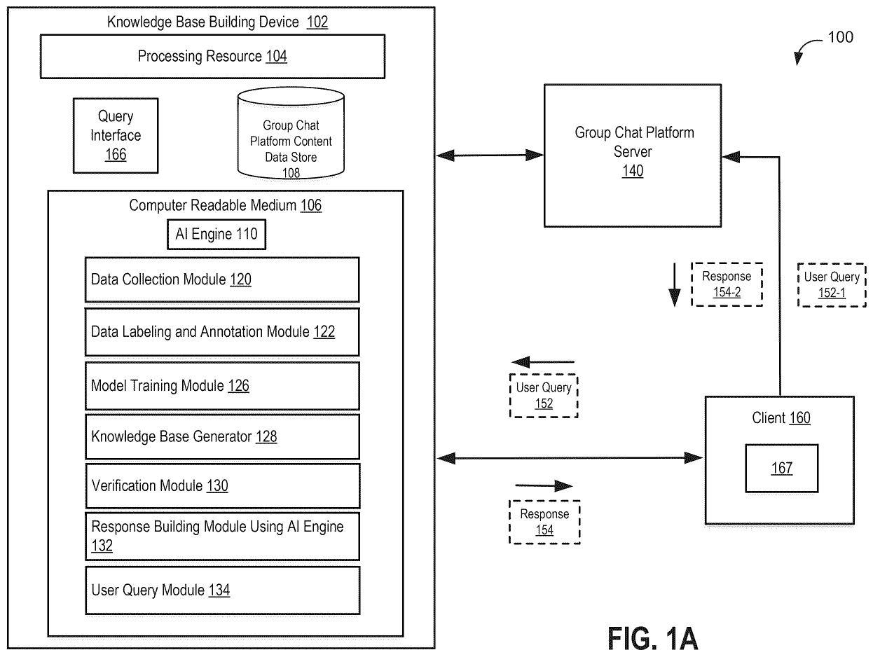

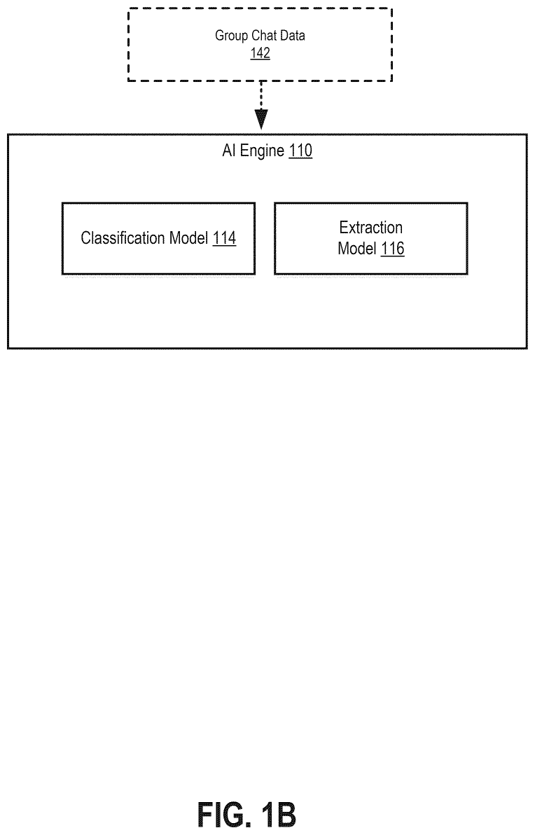

FIG. 1A illustrates an example network 100 including a knowledge base building device 102, a one or more group chat platform device 140, and a client computing device 160 for generating a knowledge base from data exchanged within a group chat messaging platform to build enabling users to find relevant information effectively without manually searching through messages or using simple search functions, in accordance with some examples described herein. The network 100 may include any number of systems and clients, without limiting the scope of the present disclosure.

The knowledge base building device 102 may comprise an example processing resource 104 and an example machine-readable medium 106. The processing resource 104 may be implemented using a general-purpose or special-purpose processing engine such as, for example, a microprocessor, controller, or other control logic. The processing resource 104 may be connected to a bus, although any communication medium can be used to facilitate interaction with other components of the corresponding device that embeds processor 104 or to communicate externally. The processing resource 104 may include different types of processing units (also referred to as service provider resources), such as Central Processing Unit (CPU), Graphical Processing Unit (GPU), and the like.

The machine-readable medium 106 may be implemented as random-access memory (RAM) or other dynamic memory, to be used for storing information and instructions 120-134 to be executed by processor 104. For example, the computer program components may include one or more of a data collection module 120, a data labeling and annotation module 122, a model training module 126, a knowledge base generator module 128, a verification module 130, a response building module using AI engine 132, and a user query module 134, and/or other such components. Other memory might also be used for storing temporary variables or other intermediate information during execution of instructions to be executed by processor 104 or a read only memory (“ROM”) or other static storage device coupled to the bus for storing static information and instructions for processor 104.

The machine-readable medium 106 includes memory resources (e.g., cache memory), storage resources (e.g., non-volatile storage devices), and the like. The machine-readable medium 106 may comprise various engines and modules to be executed by processor 104.

For example, at knowledge base building device 102, computer readable media 106 may comprise an AI engine 110. The knowledge base data generated by the processes of the knowledge base building device 102 may be stored in knowledge base data store 108. Furthermore, the training and content specific and corresponding data used by the AI engine 110 may be stored in knowledge base data store 108.

In FIG. 1, although the network 100 is shown to include knowledge base building device 102, a group chat platform server 140, and a client 160, the network 100 may include any number of systems and clients, without limiting the scope of the present disclosure.

In some embodiments, the knowledge base building device 102 may include one or more distributed applications implemented on client computing device 160 as client applications.

In some examples, the network 100 is a distributed network where the knowledge base building device 102, the group chat platform server 140, and client 160 are located at physically different locations (e.g., on different racks, on different enclosures, in different buildings, in different cities, in different countries, and the like) while being connected via the network 100. In other examples, any combination of the knowledge base building device 102, the group chat platform server 140 and the client 160 may be co-located, including running as separate virtual devices on the same physical device.

In some embodiments, a distributed communication platform application 166 may be operable by processing resource 104 configured to execute machine-readable instructions of machine-readable medium 106 comprising applications, engines, or modules, including computer program components.

The corresponding client communication platform application 167 may be configured to provide client functionality to enable a user to utilize a knowledge base constructed by the knowledge base building device 102 from data exchanged within a group chat messaging platform 140. Users by transmit queries 152 and receive relevant information, e.g., as responses 154, as implementations within the client communication platform application 167 via a user interface provided on client computing device 160. In some embodiments, the corresponding client communication application 167 may include a chat-based interface. For example, the user may enter natural language commands in an effort to search for relevant information generated by knowledge base building device 102. In other embodiments, the interface may include a GUI and/or a combination of the chat-based and GUI.

In some embodiments, automated software assistants or bots may be provided via a chat-based interface of the client communication platform application 167 configured to assist the user. For example, the automated assistant or bot may interact with users through text, e.g., via a chat-based interface of the distributed communication platform application 167 by responding to user request. The automated software assistant may be implemented by utilizing the processes of the knowledge base building device 102, as described herein.

In some embodiments, client computing device 160 may include a variety of electronic computing devices, such as, for example, a smartphone, tablet, laptop, computer, wearable device, television, virtual reality device, augmented reality device, displays, connected home device, Internet of Things (IOT) device, an enhanced general packet radio service (EGPRS) mobile phone, a media player, a navigation device, a game console, a television, a remote control, or a combination of any two or more of these data processing devices, and/or other devices. In some embodiments, client computing device 160 may present content to user 150 and receive customer message input.

In some embodiments, client computing device 160 may be equipped with GPS location tracking and may transmit geolocation information via a wireless link and network 100. In some embodiments, knowledge base building device 102 and/or group chat platform server 140, may use the geolocation information to determine a geographic location associated with client 160. For example, knowledge base building device 102 and/or group chat platform server 140 may use signal strength, GPS, cell tower triangulation, Wi-Fi location, or other input to determine location. In some embodiments, the geolocation of client 160 may be used by knowledge base building device 102 and/or group chat platform server 140 when identifying location parameters when processing user requests.

In some embodiments, one or more group chat platform device 140 may be integrated with the knowledge base building device 102 to access and collect data exchanged by users of group chat platforms or services for the purposes of generating a chat group knowledge base, as described in further detail below. Examples of such group chat platforms or services may include but are not limited to, e.g., Slack®, WhatsApp®, Microsoft Teams®, among other group chat platforms, programs, and/or services. Information from these group chat platforms may be stored in the knowledge base data store 102 to for use by the knowledge base building device 102. In some embodiments, one or more group chat platform device 140 may include one or more processors, memory and network communication capabilities (not shown). In some embodiments, group chat platform device 140 may be a hardware server connected to network 103, using wired connections, such as Ethernet, coaxial cable, fiber-optic cable, etc., or wireless connections, such as Wi-Fi, Bluetooth, or other wireless technology. In some embodiments, group chat platform device 140 may transmit data between one or more of the knowledge base building device 102 and client computing device 160 via network 100.

As alluded to above, the knowledge base building device 102 may include a data collection module 120, a data labeling and annotation module 122, a model training module 126, a knowledge base generator module 128, a verification module 130, a response building module 132 using an AI engine, and a user query module 134. These components, when executed by the processing resource 106, operate collectively to collect and process data, including labeling and training, and to build and process both specific-user-content-based requests and non-specific-user-content-based requests (e.g., requests 152). The modules further enable the system to understand conversational context and orchestrate responses by leveraging AI models.

In some embodiments, the knowledge base building device 102 includes a data collection module 120 configured to integrate with any existing group chat platform (e.g., group chat platform server 140) to continuously monitor and collect the messages exchanged by users within group conversations in real-time. For example, as users interact in real-time, exchanging messages related to various topics such as recommendations, reviews, advice, and personal experiences, the data collection module 120 seamlessly integrates with group chat platform (such as Slack, Microsoft Teams, Discord, WhatsApp, etc.) to access and collect data exchanged by users.

The data collection module 120 continuously monitors and collects messages, attachments, images, and other shared content in real-time. The collected data is preprocessed to remove noise, irrelevant content, or sensitive information, ensuring that only useful data is retained for further processing.

In some embodiments, the knowledge base building device 102 may include a data labeling and annotation module 122 configured to automatically label collected chat data to automatically identify and label entities (such as names, dates, locations, product names, etc.) and classify user intents (such as questions, requests, suggestions, etc.) from the chat messages (e.g., using natural language processing (NLP) techniques).

In some embodiments, the data labeling and annotation module 122 labels the chat data to create a training dataset. The labeled training data set may be stored in data store 108, which will be used to train AI models utilized herein. For example, the data labeling and annotation module 122 may use AI engine 110, illustrated in FIG. 1B, to label incoming chat data 142. For example, classification model 114 and extraction model 116 of AI engine 110 in FIG. 1B, as described further below, may be used to label chat data 142. The labeling may be performed based on intent classification configured to identify the user's intent behind each message (e.g., asking for advice, providing a review, making a statement), and entity extraction configured to extracting relevant entities such as products, locations, names, dates, etc. (e.g., “restaurant,” “loan rate,” “broker”).

In some embodiments, the data labeling and annotation module 122 may refine the labels over time as more data is collected and verified, adjusting them based on user feedback or follow-up messages.

In some embodiments, the data labeling and annotation module 122 may allow for manual review and correction of automatically labeled data by human annotators to ensure high-quality labeled datasets.

In some embodiments, the knowledge base building device 102 may include a model training module 126 configured to train the AI engine 110 of FIG. 1B, as alluded to above. In particular, the classification model 114 of engine 110 in FIG. 1B is trained using labeled training data to learn how to classify user messages into different categories, such as “question,” “review,” “suggestion,” or “statement,” to accurately detect user intents in the context of group chat interactions. By using the labeled training data, generated by data labeling module 120, the classification model 114 is trained to learn from diverse user queries and intents to classify new inputs effectively.

Similarly, the extraction model 116 of engine 110 illustrated in FIG. 1B is trained using the labeled data to identify and extract relevant entities from user messages. For example, the extraction model 116 is trained to extract entities from the messages, e.g., names of restaurants, products, or specific details such as “low-interest loan” or “first-time buyer.” The extraction model 116 is optimized to recognize entities specific to the group chat content, such as frequently mentioned products, services, or topics.

In some embodiments, the model training module 126 may be configured to periodically retrain the models using newly labeled data to adapt to evolving user behavior, new entities, and changing conversation patterns.

In some embodiments, the knowledge base building device 102 may include a knowledge base generator module 128 configured to build a structured knowledge base from the information extracted from group chat messages using the trained AI engine 110 of FIG. 1B, as described above.

The knowledge base generator module 128 may use the trained AI engine 110 of FIG. 1B to analyze the processed group chat data to identify valuable information, frequently asked questions, important topics, and insights, construct a structured knowledge base 108 containing summarized information, key points, and answers derived from the group chat, and organize the knowledge base into categories, such as topics, entities, or user intents, and indexes the content to support fast and efficient retrieval. For example, the AI engine of FIG. 1B may categorize chat group information, including such categories as recommendations (e.g., “this restaurant is good”), financial information (e.g., “first-time buyers can get low-interest loan”), and product reviews, service experiences, or other valuable insights shared in the chat group. Finally, the knowledge base generator module 128 through the AI engine 110 of FIG. 1B may augment the knowledge base by integrating external data sources (e.g., company documents, manuals, databases) to provide comprehensive answers to user queries. For example, the knowledge base generator module 128 may automatically organize the extracted information into knowledge base entries, each linked to the original message or discussion thread for context.

In some embodiments, the knowledge base building device 102 may include a verification module 130 configured to continuously monitor future group messages to verify the accuracy of the stored knowledge. For example, the verification module 130 may use message generated at a later time (e.g., follow-up confirmations or clarifications in future conversations) to validate the initial statements made by users. If someone posts “I wonder if this restaurant is good” and later confirms, “I liked it,” the system can update the knowledge base, marking the restaurant as “likely good.”

In other embodiments, the verification module 130 may use external sources (e.g., online reviews, news sites, financial updates) for verification. For instance, in the case of the restaurant review example, the verification module 130 may search online reviews to confirm that other customers also rate the restaurant positively. Similarly, for financial or service-related assertions (e.g., “We can get a loan as first-time buyers at a low rate”), the verification module 130 may check authoritative online sources (e.g., financial institutions, news articles) to ensure the information is both correct and up to date. If the information from external sources contradicts the user's original assertion or if circumstances change (e.g., interest rates go up), the verification module 130 may flag this in the knowledge base and potentially update or correct the information.

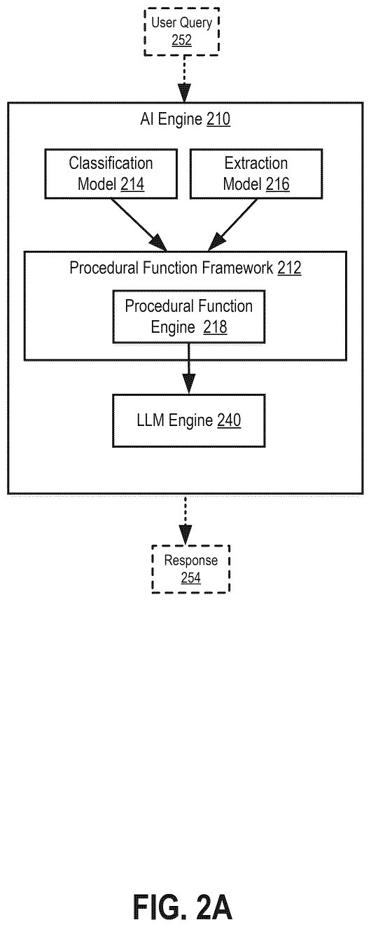

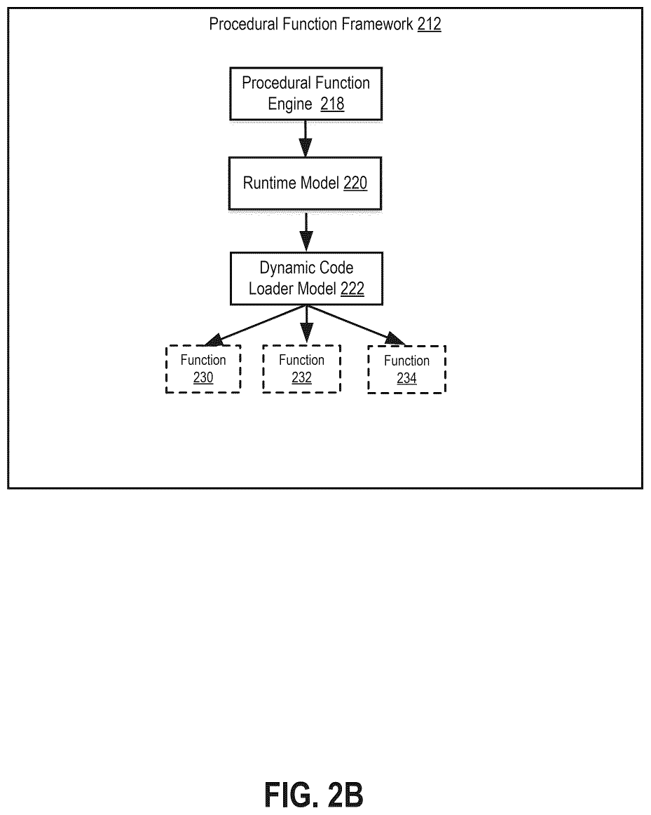

In some embodiments, the knowledge base building device 102 may include a response building module using AI engine 132, configured to utilize AI engine 210, as illustrated in FIG. 2A. In some embodiments, the AI engine 210 may be the same AI engine 110 illustrated in FIG. 1A used by modules 120-134 of the knowledge base building device 102. In other embodiments, the AI engine 210 may be a different engine (other than the AI engine 110 illustrated in FIG. 1A). The AI engine 210 may be configured to act as the core backend component that dynamically handles user interactions, understands user queries, and orchestrates responses based on the knowledge base 108 generated by the knowledge base generator module 128, as explained above.

For example, a user may submit a query 152 to and receive a response 154 from the knowledge base building device 102 via the client communication platform application 167 provided on client computing device 160.

The response building module 132 of the knowledge base building device 102 receives a query 152 from a client 160 over the network 100. The response building module 132 processes the query 152 using AI engine 110. The output of the AI engine 110 is transmitted back to the response building module 132 and is implemented as a response 154 to query 152. For example, the response 154 may be implemented within distributed communication platform application 166 accessible to users via a corresponding client communication platform application 167 provided on client 160.

For example, a user may submit a query 152 to the system (e.g., “Is the restaurant good?” or “Can I still get a low-interest loan?”). In response, the classification model 214 of AI engine 210 illustrated in FIG. 2A (similar to the AI engine 110 illustrated in FIGS. 1A, 1B) may be used to identify the user's intent and the extraction model 216 to retrieve relevant entities from the query 152. For example, the classification model 214 may determine the intent behind each user query, such as seeking information, asking a question, or requesting a specific action. Similarly, the extraction model 216 may identify key entities within the user query that are crucial for generating accurate and context-aware responses. Next, the AI engine 210 may be configured to dynamically invoke relevant procedural functions using the AI engine architecture. The procedural function engine 218 may dynamically generate procedural functions to perform specific tasks, such as retrieving relevant content from the knowledge base 108, generating responses, or executing actions requested by the user. For example, the procedural function engine 218 retrieves the relevant information from the knowledge base 108 (constructed by knowledge base building device 102 and illustrated in FIG. 1A), providing the user with a direct response 154, as illustrated in FIG. 1A, based on previous conversations or newly verified knowledge. If the information is time-sensitive (e.g., financial rates), the system may perform real-time verification by checking external sources before responding. If multiple discussions exist on a topic (e.g., different opinions about a restaurant), the system can present a summary or analysis of the varied opinions, giving the user a comprehensive answer.

In some embodiments, the knowledge base building device 102 may include a user query module 132 configured to facilitate user's questions or requests directly within their existing group interface. For example, the user query module 130 may be integrated with the group chat platforms 140. The user may us their client computing device 160 to submit a query 152-1 and receive a response 154-1 via a user interface associated with the group chat platform server 140 which has been integrated with the knowledge base building device 102.

Users can type natural language queries in the chat, and the system processes these queries in real time to provide relevant answers or perform the requested actions. The response generated by the response building module 132 of the knowledge base building device 102 may provide personalized responses and content tailored to the user's specific context, preferences, and past interactions, as alluded to above.

In some embodiments, the users of the knowledge base building device 102 may provide feedback on the accuracy of the responses, helping to further refine the classification and extraction models, e.g., classification model 114 and extraction model 116 illustrated in FIG. 1B. By learning from these interactions, the knowledge base building device 102 continuously improves its knowledge base and enhances the accuracy of future responses.

As alluded to above, the knowledge base building device 102 (illustrated in FIG. 1A) may comprise an AI engine 110 (illustrated in FIG. 1B) which is executable by the processing resource 106 to allow users to find relevant information quickly without manually searching through messages on the group chat platform (e.g., group chat platform 140) or relying on simple keyword searches. Instead, the response building module using AI engine 132, uses AI engine 110 to understand the context of the query and return structured, verified responses from the knowledge base. The AI engine 110 defines a software architecture to execute components on the knowledge base building device 102 for processes user input (i.e., request such as request 152) understands the context, and orchestrates responses (e.g., responses 154) within the location-based or interest-based communication platform provided by group chat platform server 140.

As illustrated in FIG. 2A, AI engine 210 may comprise a classification model 214 and an extraction model 216 which is integrated with a procedural function framework 212 that includes a procedural function engine 218, and a pre-trained LLM 240.

The request 252 may be provided as input to a classification model 214 and extraction model 216 which may in turn provide their input to procedural function framework 212. The procedural function framework 212 which is integrated with the classification model 214 and extraction model 216 may receive the output generated by models 214 and 216 as input via its procedural function engine 218. In some examples, the procedural function framework 212 may include the pre-trained LLM 240. The output of the procedural function framework 212 may include the response 254 to request 252.

In some embodiments, the classification model 214 is configured to identify the user's goal or purpose behind the request. In speech processing, detecting the goal or purpose means identifying what the user wants to achieve or communicate with their utterance. The classification model 214 detects and categorizes multiple intents from a given input. The classification model 214 helps in guiding the AI engine 210 to understand which dataset or function to use to respond appropriately to the user's request. In some embodiment, the classification model 214 provides the first layer of understanding to ensure the system knows the user's objective, which directs the flow of information processing. The classification model 214 uses machine learning algorithms, such as natural language processing (NLP), to analyze text and classify it into predefined categories (e.g., “romantic date restaurants,” “verified,” “find a housekeeper,” etc.). In some embodiments, the NLP models used for classification tasks in include Logistic Regression (e.g., a model for binary classification tasks), Support Vector Machines (SVMs) (e.g., for separating data into different categories), Neural Networks (e.g., deep learning models like RNNs, Long Short-Term Memory (LSTM) networks, and transformers, which are particularly effective in handling complex language tasks), and other similar models. Once the intent is determined, the procedural function framework 212 uses this information to decide which specific procedural function or set of functions (cells) should be executed to fulfill the user's request.

In some embodiments, the classification model 214 may use supervised learning techniques where it is trained on labeled data. For example, a dataset containing user requests and their corresponding intents is used to train the model. The model 214 learns from this data to predict the correct intent of new, unseen queries. It may also employ advanced NLP techniques, such as transformers or recurrent neural networks (RNNs), to understand the context and nuances of human language. In other words, the model 214 has learned to classify input based on pre-annotated examples. In some embodiments, labeled data may be stored in data store (e.g., data store 108 illustrated in FIG. 1A) and include manually labeled or annotated data to indicate the correct user intent (i.e., action that the model should be taking) for specific tasks and to provide explicit examples for the model to learn from. The labeled training data stored in data store may include the data collected from the group chat platform.

Additionally, the labeled data may include a manually labeled micro-intent and an action attribute. The labeled data may be domain-specific and directly tied to a particular task (e.g., obtaining restaurant recommendation for a particular weekend). For example, intent identification data may have labels indicating the specific user intent that can be associated with each sentence.

Once the training data has been labeled, it can be used to train the classification model 214 to process labeled user requests to determine user intent.

The classification model 214 learns from the sample data which has been labeled. The more sample data is provided to the model the more accurate the model will be at detecting a particular intent.

The extraction model 216 is used to identify and extract parameters (or entities) from the user's input. Parameters (or entities) are specific pieces of information or data points that provide context or details necessary to complete the action associated with the detected intent (e.g., names, dates, locations, quantities) of the user made by model 214. In speech processing, identifying parameters (or entities) means extracting meaningful and relevant pieces of data from the user's input. The extraction model 216 tags relevant parameters (or entities) in the input text and extracts a set of query parameters associated with the identified query intent. In some embodiments, the extraction model 216 may obtain parameters from a domain-specific database.

The extraction model 216 uses machine learning algorithms, such as natural language processing (NLP), to o recognize and extract these parameters (or entities) from text. In some embodiments, the NLP models used for classification tasks in include Named Entity Recognition (NER): (e.g., a model for binary classification tasks), Conditional Random Fields (CRF) (e.g., a probabilistic model often used for structured prediction, particularly effective for sequence tagging tasks like entity extraction), Neural Networks (e.g., Recurrent Neural Networks (RNNs), Long Short-Term Memory (LSTM) networks, and transformers, which can handle complex patterns in language and context), Named Entity Recognition (NER) Models (e.g., based on machine learning algorithms like CRFs, HMMs (Hidden Markov Models), or deep learning approaches), Transformer-Based Models: Such as BERT (Bidirectional Encoder Representations from Transformers) or GPT (Generative Pre-trained Transformer), which can understand context and extract entities with high accuracy, and other similar models. The extracted parameters (or entities) serve as parameters or arguments for the procedural functions of procedural framework 212 that are executed. The procedural function framework 212 dynamically uses these parameters (or entities) to ensure that the correct data is used in each function.

The extraction model 216 may be trained using supervised learning techniques with labeled datasets, where the training data includes examples of text annotated with the entities that the model needs to recognize. The labeled training data used to train the extraction model 216 is described above, in reference to the classification model 214.

### Procedural Function Engine 218

The procedural function framework 212 leverages both the classification model 214 (for detecting intents) the extraction model 216 (for identifying entities) to understand user requests and uses engine 218 which creates and executes procedural functions based on the detected user intent and entities to identify the user's intent. For example, based on the identified intent, engine 218 determines which functions or workflows need to be executed by engine 218 to address the identified intent. In some embodiments, this selection may be based on predefined mappings between detected intents and the available functions. In other embodiments, engine 218, may dynamically determine and generate the functions. Simultaneously, engine 218 utilizes extraction model 216 to pull out relevant entities from the input. These entities provide the necessary details that the functions require to perform the desired task. Together, these models enable the engine 218 to dynamically execute the appropriate functions or workflows needed to fulfill the user's request, making the system flexible, adaptable, and capable of handling diverse tasks in real-time. In some embodiments, engine 218 may act as a central controller or orchestrator that determines which procedural functions should be executed to fulfill the user's request.

In some embodiments, output from classification model 214 and extraction model 216 used by procedural function framework 212 to generate a partial and a full response. For example, engine 218 may receive output from the classification model 214 (intents) and the extraction model 216 (entities) extracted from the query and execute one or more actions which will formulate the response for a query comprising raw data entered by the user. In some embodiments, the engine 218 may be configured to generate a partial response. In some embodiments, the partial response generated by the engine 218 may comprise the raw output data which has been transformed into a simplistic phrase to produce a partial response. The partial response generated by engine 218 may be submitted to LLM 140 to produce the final response. In some embodiments, LLM 140 used to produce the final response may comprise a pre-trained LLM developed using an open-source LLM model (OpenChatKit) that uses 7 billion parameters and a Generative Pretrained Transformer (GPT) algorithm.

In some embodiments, procedural function framework 212 may comprise a runtime model, which is a specific component or module within the engine 218. For example, as illustrated in FIG. 2B, runtime model 220 may be configured to execute the decisions made by the procedural function engine 218, particularly concerning which procedural functions to run and how they should be executed, as illustrated in FIG. 1B. The runtime model 220 may handle the real-time execution of procedural functions based on the intent and entity information provided by models 214 and 216, respectively. It serves as the runtime environment where decisions are operationalized—converting the output of the intent and entity detection into specific actions performed by the procedural functions. The runtime model 220 may use a command selector (not illustrated) to determine which procedural functions to execute based on the identified intents and extracted entities.

In some embodiments, the runtime model 220 may comprise a dynamic code loader 222 that dynamically loads and executes the required procedural functions 230, 232, 234 based on the decisions made by the runtime model 220, ensuring that the right functions are run at the right time. A configuration file containing the list of all supported intents and the actions associated with them may be used.

Each of the functions 230, 232, 234 is a dynamic, procedural function or unit of execution that is created or utilized to perform specific tasks based on user requests. Multiple functions can be triggered to generate a complex response. Exemplary functions may include an API Call Function (e.g., for sending a request to an external API to fetch data or perform an action, a Data Processing Function (e.g., for processing input data to perform calculations, transformations, or analysis), a Web Search Function (e.g., for conducting a web search to find external information not available in the current dataset), an Interaction Function (e.g., for communicating with other AI systems or services to exchange information or trigger additional tasks).

In some embodiments, procedural functions 230-234, i.e., individual execution units may include logic-based routines, or task-specific scripts that perform discrete operations. For example, a function may include if/else logic. Such functions would not “learn” from data in the way neural networks do. Instead, they are invoked dynamically based on the identified intents and extracted entities to perform predetermined actions. Unlike neural networks, which are trained models that learn patterns from data, functions that are rule-based or predefined are designed to execute specific tasks.

In some embodiments, procedural functions, i.e., individual executions units may use neural network functions that are designed to handle specific tasks associated with the intent. A neural network is a computational model inspired by the way biological neural networks in the human brain process information. It consists of interconnected layers of nodes (neurons) that work together to learn patterns, representations, and relationships in data.

In some embodiments, the runtime model 220 may be configured to execute the decisions made by the engine 218, particularly concerning which procedural functions to run and how they should be executed, as illustrated in FIG. 2B. Runtime model 220 may handle the real-time execution of procedural functions based on the intent and entity information provided by models 214 and 216, respectively.

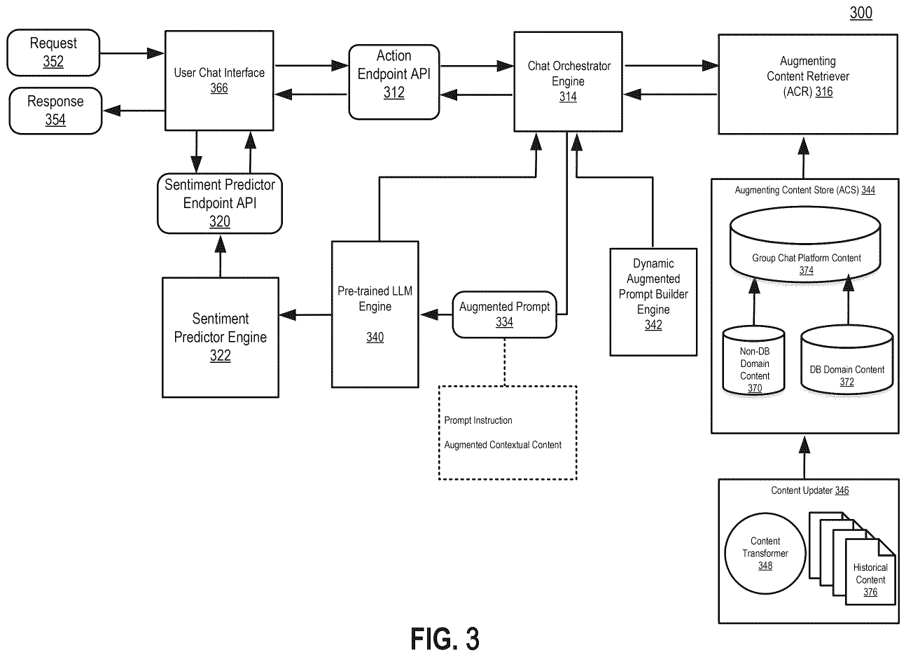

FIG. 3 is an illustrative process for generating a response to a query using procedural functions generated and executed by the procedural function framework 212 of AI engine 210, illustrated in FIG. 2B, in accordance with some examples described herein. In example 300, a process associated with generating a response is illustrated using various system, including a system comprising a conversation engine. The system executing machine-readable instructions in example 300 may correspond with knowledge base building device 102 in FIG. 1A.

A new query 352 may be generated by a user via communication platform 266, which may be implemented with knowledge base building device 102 illustrated in FIG. 1A and may correspond with distributed communication platform application 166 in FIG. 1A.

User chat interface 266 (or, alternatively, user chat interface of chat platform 140 illustrated in FIG. 1A if the query user query module is integrated with the platform 140 directly) simultaneously sends query 352 to a request endpoint application programming interface (“API”) 312 for response generating tasks and to a sentiment predictor endpoint application programming interface (“API”) 320 for sentiment detection tasks. The action endpoint API 312 receives the request from the user chat interface 266 and forwards it to the response orchestrator engine 314 for processing. Response orchestrator engine 314 may be a central coordination module that receives user query 352 from the action endpoint API 312 and manages interactions with other system components. Response orchestrator engine 314 orchestrates the retrieval of relevant content, prompt construction, activation of the LLM for response generation, and/or content updater 346.

Simultaneously, as the request endpoint API 312 receives the query 352, the sentiment predictor endpoint API 320 also receives user query 352 and forwards the input to a sentiment predictor engine 322.

Sentiment predictor engine 322 utilizes LLM 340 to analyze the sentiment of the content in “sentiment prediction mode,” by generating a sentiment classification (e.g., “negative” or “non-negative”). The LLM 340 may be a pre-trained LLM and may comprise an open-source large language model (such as OpenChatKit) with generative capabilities, utilizing a generative pretrained transformer (GPT) algorithm. The LLM 340 may be invoked twice: first for sentiment analysis and second for generating a response based on the dynamically constructed prompt, as described herein.

The response orchestrator engine 314 calls the augmenting content retriever (ACR) engine 316 to find relevant content from the augmenting content store (ACS) 344 using a semantic search engine. For example, the ACR engine 316 uses a semantic search engine (e.g., FAISS) to search for and retrieve content from the ACS 344 that semantically matches the user's request.

The ACS 344 comprises a repository of data built by the knowledge base generator module 128 (illustrate in FIG. 1A) from the information extracted from group chat messages using the trained AI engine 110 of FIG. 1B, as described above. The ACS 344 may include group chat platform content 374. The ACS 344 may also dynamically incorporate content retrieved via API calls and database look-ups during content verification (e.g., by data verification module 130 illustrated in FIG. 1A).

The data in group chat platform datastore 374 may include structured data 370 and unstructured data 372. The structured data 370 includes information that is typically organized in tables and can be queried using database management systems (DBMS) like SQL, NoSQL, or other types of databases. This data 370 is highly structured, following a specific schema or format (e.g., rows and columns in relational databases, document-based storage in NoSQL databases). Furthermore, this content 370 may be specific to the domain or context of the community group or sub-group. It could include records such as user information, login information, request information generated and response information received, request topic, response topic, and other relevant request details. The content 370 can be dynamically updated as new data is entered or modified in the database. For example, structured data 370 may include information about schools, and community events, vendors, service providers, rules and regulations and/or other location-related information.

The unstructured data 372 includes content that is not stored in a structured database but is still specific to the company or domain. This content 372 could be in the form of documents, files, internal reports, manuals, emails, presentations, or any other format that is stored outside traditional databases. While data 372 it is specific to the organization's domain it is often unstructured (e.g., text documents, PDFs, presentations) or semi-structured (e.g., JSON files, XML data) and it resides in different formats and storage systems. The unstructured data 372 may come in various formats, such as Word documents, PDFs, images, spreadsheets, or even web pages within the company's intranet, and other similar formats. For example, unstructured data 372 may include school recommendation lists, community rule books, neighborhood guides, event flyers, and similar information. Both structured data 370 and unstructured data 372 play crucial roles in providing comprehensive answers to user queries. For example, when the ACR engine 316 retrieves content relevant to the user's query, that content may either be structured data 370 (i.e., data that directly answers or supports the user's question) or unstructured data 372 (i.e., by performing a semantic search (e.g., using FAISS) across unstructured or semi-structured content 372 to find documents, articles, or other files relevant to the query. Accordingly, the ACR engine 316 retrieves and integrates both structured data 370 and unstructured data 372 content and then used by the dynamic augmented prompt builder (DAPB) engine 342 to create a tailored prompt for the LLM 334, which includes instructions and the most relevant content slices so that the conversation allowing engine 310 can construct a comprehensive and context-aware response.

In some embodiments, the data in the ACS 344 is continuously updated and maintained with relevant and up-to-date group chat platform content with a content updater 346. By using content updater 346, ensures that the content is used to enrich the responses generated by the system, ensuring that the answers provided are accurate, current, and contextually relevant.

The content updater 346 collects new data from group chat platform as well as other sources (such as external APIs, databases, real-time feeds, or internal repositories) and integrates this content into the ACS 344. It ensures that the information in the ACS 344 remains fresh and relevant by regularly adding new data and removing outdated or irrelevant information.

The content updater 346 dynamically enhances the group chat platform content data store by incorporating recent group chat messages that are pertinent to user queries. In some embodiments, the content updater 346 may also retrieve updated external content such as policy documents, management company details, FAQs, or other relevant information, which is then stored in the ACS 344 for future use. For example, in a homeowners'association (HOA) context, the system may integrate updated HOA rules and notices into the ACS 344. By maintaining the ACS 344 with current chat-derived and external content, the system is able to generate responses based on the latest available information, thereby enhancing both the accuracy and the relevance of answers provided to users.

The content updater 346 integrates with external content sources (such as APIs, web crawlers, or news feeds) and internal databases or knowledge management systems. This allows it to retrieve relevant content in real time, ensuring that the system always has access to the most current data. For example, in an enterprise scenario, content updater 346 may pull data from CRM systems, employee handbooks, or product catalogs to enrich responses to user requests.

Before updating the ACS 344, the content updater 346 preprocesses the content (i.e., content extracted from group chat messages) to ensure that it is properly formatted and indexed for fast retrieval. This may include removing irrelevant or sensitive data, parsing and structuring the content in a way that makes it easily searchable, creating metadata tags or labels that improve the accuracy of search results when the system queries the ACS 344. In some embodiments, content transformer 348 is configured in taking raw, unstructured, or semi-structured data (e.g., text, documents, files) retrieved by the content updater 346 from external APIs, internal databases, or other content sources and transforming it into a structured and useful format before it is stored in the ACS 344.

The content updater 346 works closely with the ACR engine 316 to ensure that the content retrieved during user interactions is relevant and up-to-date. The content updater 346 also collaborates with the dynamic augmented prompt builder (DAPB) engine 342 to ensure that the system has access to enriched content that can be used to build detailed and contextually relevant prompts for the LLM 340.

In some embodiments, historical content 376 is used to provide context and enhance the relevance of new content being added by the content updater 346. By referencing past content, the system can maintain continuity and context in responses. Historical content 376 could include previous chat interactions, older versions of documents, or past event data. This helps the system provide consistent answers that reflect both new information and historical trends or patterns. The content updater 346 can reference historical content 376 to identify trends or patterns that inform how new content should be integrated into the ACS 344. For instance, if a pattern of user requests shows increasing interest in a particular topic or subject, this may influence how content is prioritized and updated. By leveraging historical content 376, the system can predict what type of information might be most relevant based on previous interactions and update the store accordingly. When a user asks a question, the ACR engine 316 may pull both real-time and historical content 376 to ensure that the response is accurate and reflects any updates or changes over time. The content updater 346 ensures that historical and current data are harmonized in the ACS.

The response orchestrator engine 314 sends the retrieved content to the dynamic augmented prompt builder (DAPB) engine 342, which may be configured to construct a prompt comprising an instruction and relevant content slices retrieved by the ACR engine 314.

The response 354 is sent back to the chat orchestrator 314, which forwards it to the request endpoint API 312 for delivery to the communication platform application 166 in FIG. 1A.

The components described in FIG. 3 may be initiated as procedural functions of procedural function engine 218 of the AI engine 210 described with respect to FIG. 2A. For example, when a query is received (e.g., a query 152 in FIG. 1A or query 252 in FIG. 2A), the engine 218 may generate a procedural function to initiate the sentiment predictor engine 322. This function uses the pre-trained LLM 240 in “sentiment prediction mode” to analyze the sentiment of the request. Simultaneously, another procedural function may be generated to activate a chat orchestrator 314, which coordinates with the ACR engine 316 to search and retrieve relevant content from the ACS 344.

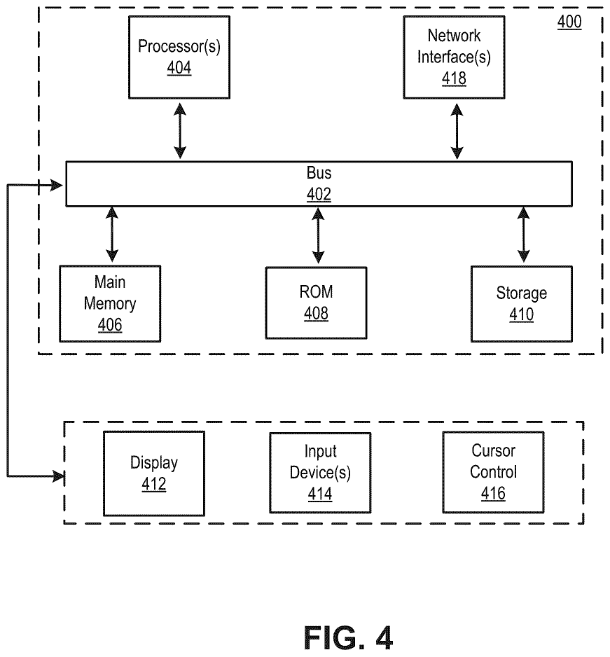

Once the relevant content is retrieved, the procedural function engine 218 in FIGS. 2A-2B may generate a procedural function to call the DAPB engine 342, which constructs a tailored prompt for the Pre-Trained LLM 340. This prompt combines the user's request with the retrieved content to ensure that the response generated by the LLM 340 is accurate and context specific. The DAPB engine 342 creates an enriched or refined prompt that includes additional context or instructions, which can be fed to the LLM engine 240 (illustrated in FIG. 2A) in the AI engine 210 to enhance its understanding and improve the quality of the response. The ACR 316 fetches relevant data from various content stores (e.g., knowledge bases, databases such as 108 illustrated in FIG. 1A), which can be incorporated into the LLM's input to provide more comprehensive answers. The sentiment predictor engine 322 output can guide the LLM 340 (and LLM engine 240 in FIG. 2A) to adjust the tone or style of its responses based on the user's perceived sentiment, ensuring a more empathetic or appropriate reply.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 4. Various embodiments are described in terms of this example computing module 400. After reading this description, it will become apparent to a person skilled in the relevant art how to implement the technology using other logical circuits or architectures.

FIG. 4 illustrates an example computing module 400, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 1. Various embodiments are described in terms of this example-computing module 400. After reading this description, it will become apparent to a person skilled in the relevant art how to implement the application using other computing modules or architectures.

Referring now to FIG. 4, computing module 400 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally. The bus 402 may also be connected to other components such as a display 412, input devices 414, or cursor control 416 to help facilitate interaction and communications between the processor and/or other components of the computing module 400.

Computing module 400 might also include one or more memory modules, simply referred to herein as main memory 406. For example, preferably random-access memory (RAM) or other dynamic memory might be used for storing information and instructions to be executed by processor 404. Main memory 406 might also be used for storing temporary variables or other intermediate information during execution of instructions to be executed by processor 404. Computing module 400 might likewise include a read only memory (“ROM”) 408 or other static storage device 410 coupled to bus 402 for storing static information and instructions for processor 404.

Computing module 400 might also include one or more various forms of information storage devices 410, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 410 might include other similar instrumentalities for allowing computer programs or other instructions or data to be loaded into computing module 400. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 400.

Computing module 400 might also include a communications interface or network interface(s) 418. Communications or network interface(s) interface 418 might be used to allow software and data to be transferred between computing module 400 and external devices. Examples of communications interface or network interface(s) 418 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 418 might typically be carried on signals, which can be electronic, electromagnetic (which includes optical) or other signals capable of being exchanged by a given communications interface. These signals might be provided to communications interface 418 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 406, ROM 408, and storage unit interface 410. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method, comprising:
collecting group chat data from a communication platform;
automatically labeling the group chat data with metadata comprising at least user intents, entities, or domain-specific tags;
training, using the labeled group chat data, a classification model to detect user intents and an extraction model to identify entities;
generating knowledge base entries based on outputs of the classification model and the extraction model;
verifying the generated knowledge base entries by cross-referencing subsequent group chat content or external data sources; and
responding to a user query using at least one verified knowledge base entry.

2. The method of claim 1, wherein verifying the generated knowledge base entries comprises detecting corrections or confirmations expressed in subsequent group chat messages.

3. The method of claim 1, wherein verifying comprises comparing the generated knowledge base entries against an external trusted data source.

4. The method of claim 1, wherein the knowledge base entries comprise structured data derived from database records and unstructured data derived from chat documents or free-text content.

5. The method of claim 1, wherein responding to the user query comprises dynamically constructing a prompt that integrates verified knowledge base entries and executing the prompt with a language model.

6. The method of claim 1, wherein the system stores only metadata identifying the knowledge base entries and dynamically regenerates query responses, thereby reducing retraining and storage overhead.

7. A system comprising:
one or more processors; and
a non-transitory machine-readable medium storing instructions that, when executed by the one or more processors, cause the system to:
collect group chat data from a communication platform;
automatically label the group chat data with metadata comprising at least user intents, entities, or domain-specific tags;
train a classification model to detect user intents and an extraction model to identify entities using the labeled group chat data;
generate knowledge base entries based on outputs of the classification model and the extraction model;
verify the generated knowledge base entries by cross-referencing subsequent group chat content or external data sources; and
respond to a user query using at least one verified knowledge base entry.

8. The computer system of claim 7, wherein the verification is performed by a verification module configured to monitor subsequent group chat content for corrections or confirmations.

9. The computer system of claim 7, wherein the knowledge base entries include both structured and unstructured content.

10. The computer system of claim 7, wherein the system further comprises a procedural function engine configured to generate prompts integrating verified knowledge base entries for execution by a pre-trained language model.

11. The computer system of claim 7, wherein the system stores only metadata identifying a knowledge base entry and dynamically regenerates query responses without storing full workflow state data.
